(19) United States
(12) Patent Application Publication
(10) Pub. No.: US 2004/0216955 A1
(43) Pub. Date: Nov. 4, 2004

(54) Multipurpose ladder standoff

(76) Inventor: Eugene Unger, Somerset, NJ (US)

Correspondence Address: Charles I. Brodsky, Esq., 2 Bucks Lane, Marlboro, NJ, 07746, US

(21) Appl. No.: 10/425,043

(22) Filed: Apr. 29, 2003

(51) Int. Cl. E06C 7/42

(52) U.S. Cl. 182/206; 182/107

(57) ABSTRACT

A multipurpose ladder standoff especially useful for house painters and utility field workers including a jaw coupled between first and second rungs of an extension ladder and including first and second rotatable arms extending forwardly from opposing left and right jaw sides to encircle utility poles and trees, or to rest against the exterior walls and/or around the corners of a dwelling—all in a very stable, solid position.

### CROSS-REFERENCE TO RELATED APPLICATIONS

NONE

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to construction ladder standoffs, in general, and to a multipurpose extension ladder standoff, in particular.

2. Description of Related Art

As is well known and understood, such rounded objects as telephone poles, flag poles and columns are often painted with the use of “cherry pickers” or other portable equipment able to elevate the painting contractor on a first side, before being moved around to elevate the contractor on a second side. As is also appreciated, besides requiring such lift equipment to begin with, having to continually move it about is at best a major inconvenience. Using an extension ladder, instead, turns out not to be a viable alternative, as the ladder exhibits a profound tendency to slip and slide from the pole, etc.—giving rise to a very dangerous condition and a very real possibility that the contractor may fall off the ladder while working.

While the construction of the present invention will be seen especially useful in the painting of these rounded objects without the necessity of employing any wheeled lift-type of equipment, the sturdiness and stability it affords in use make it also quite beneficial in the painting of many unusual configurations on a dwelling—inclusive of painting around the corner edges of the structure. While contractors might employ ladder standoffs to enable them to straddle a building while painting, those configurations that are available only allow a positioning of the ladder to permit approximately four foot wide swaths to be covered at any instant of time. When painting above or below wide windows, on the other hand, such ladder standoff devices as are available offer problems of their own in that they cannot readily be leaned against the window while painting by brush.

And, as will further be appreciated, utility company repair personnel are faced with similar problems when working on telephone poles and at the side corners of a dwelling when bringing electricity to the house structure. Extension ladders leaning against the pole, or against the corner of the structure, simply are not stable—and portable lift equipment is frequently utilized instead.

As will be seen from the description that follows, on the other hand, the multipurpose ladder standoff of the invention allows a worker to individually adjust one or both of a pair of arms supported by the ladder in adjusting how the ladder is to rest in position, independent of the shape of the pole or exterior dwelling surface under consideration, and in a manner which is extremely stable and can be simply adjusted from one configuration to another in just a matter of a few seconds. Depending upon the adjustment, the ladder standoff of the invention can be employed at planar exteriors of a dwelling, around its corner edges, above and below wide window locations, at convoluted ells, eaves and like shapes, and at the telephone pole and flag pole configurations commonly encountered in painting and other servicing.

### SUMMARY OF THE INVENTION

As will be described below, the multipurpose ladder standoff of the invention includes a jaw having opposing left and right sides, and opposing top and bottom surfaces on each of the two sides. First and second arms—typically of a length between 2 and 4 feet (although of even greater length where desired)—are individually rotatable forwardly from the left and right jaw sides between the top and bottom jaw surfaces, respectively. First means, cooperating with the arms and jaw surfaces, operate to lock the arms at selected angles of rotation forward of the jaw, and second means, coupled to at least one of the jaw surfaces, allow the jaw to be secured to at least one rung of the ladder substantially perpendicular to its legs. As will be seen and understood, either or both of the arms could be rotated at the same, or different angles each, and of the same or different lengths depending upon the configuration or shape of the surface to be worked upon.

In a preferred embodiment of the invention, the second recited means couples the top jaw surface to a first rung of the ladder, and the bottom jaw surface to a lower, second rung. Although the two rungs are set out in the preferred embodiment as being adjacent to one another in use, such is not a requirement for solid, stable, anchoring operation, nor is the fact that in the preferred embodiment, the second means includes a substantially L-shaped plate which is secured to the top jaw surface, while extending downwardly over the first rung of the ladder called out. In similar manner, although the preferred embodiment includes a substantially L-shaped extension secured to the lower jaw surface at one end and coupled with the lower, second rung of the ladder at a second remote end thereof, other shaped extensions could be employed as well, and coupled with other than an adjacent lower rung. As will be understood, all that is required is that the jaws be secured between the rungs of the ladder, to enable the standoff arms to be individually rotatable forwardly from the jaw sides once selected of whatever length or design is desired. For example, with the preferred embodiment, a threaded U-clamp may be employed at the second remote end of the substantially L-shaped extension, with a pair of nut fasteners utilized to secure the U-clamp about the lower second ladder rung.

As reference to the accompanying drawings will readily show, the two arms of the ladder standoff couple between the top and bottom surfaces of the jaw on each of its left and right sides by way of a removable pin which extends through an aperture on one of the jaw surfaces, through an aperture on the arm itself, and through an aperture on the other jaw surface, all in overlying alignment. A cleavis type pin may be utilized in the manner, along with a cleavis pin retainer as a clasp to hold the pin in place once it is so inserted. Changing the angle of either arm is then easily accomplished by removing the pin retainer, removing the pin to rotate the arm in question to a different angle, and reinserting the pin through the two jaw surfaces and the arm at the new angulation. Replacing the pin retainer then secures the arm at the new position—whether the two arms be of the same length or not, whether the two arms are set at the same angle with respect to the midpoint of the jaw or not, and whether the two arms are of the same design or configuration. By “curving” the ends of the arms toward one another, an effective encirclement of a telephone pole, flag pole or column could be had for securing the ladder in place. Spreading the arms open, instead of closing them toward one another, allows the ends to rest against a planar wall for purposes of painting—utilizing, for example, rubberized tips as a protective cushion. By interchanging lengths of the arms, the angles of setting for the two arms, and the configuration at their end extremities allow for the multipurpose ladder standoff of the invention to then be utilized equally with rounded objects, on the exterior wall of a dwelling, around the corner of the structure, around ells, eaves and gables—all in a manner to stand away from the building while permitting a leaning thereon, with the feet of the ladder set stable on the ground as an anchor.

### BRIEF DESCRIPTION OF THE DRAWINGS

These and other features of the present invention will be more clearly understood from a consideration of the following description, taken in connection with the accompanying Drawings, in which:

FIGS. 1A-1C are top views of the multipurpose ladder standoff of the invention helpful in an understanding of its principles of operation;

FIG. 2 is a bottom view of the standoff—while FIG. 3 is a right-side pictorial view, a left side view being a mirror image;

FIGS. 4A and 4B illustrate the coupling of the multipurpose standoff to an extension ladder for use; and

FIG. 5 is an illustration helpful in understanding a manner of employing the standoff on an extension ladder in servicing (and/or painting) a telephone pole, a flag pole or a portico column.

### DETAILED DESCRIPTION OF THE INVENTION

In the Drawings, an extension ladder is shown at 10, with its legs 12 and with its rungs 14, two of which are shown as 14a and 14b. The multipurpose standoff to be secured to the extension ladder 10—or to any type of ladder for that matter—is shown at 16 as including a jaw 18 having opposing left and right sides 20, 22 and opposing top and bottom surfaces 24, 26 on each side. In accordance with the invention, first and second arms 28, 30 are individually rotatable forwardly from the left and right jaw sides 20, 22 between the top and bottom jaw surfaces 24, 26, respectively.

To effectuate this, each of the opposing top and bottom jaw surfaces 24, 26 include a plurality of overlying apertures 34, 36 on each of the opposing left and right jaw sides 20, 22. Each of the first and second arms 28, 30, likewise include an aperture 38 which is rotatable between the opposing overlying apertures 34, 36 to be aligned therewith. Such alignment may include a locking pin 40 (of cleavis type, for example) which extends through an aperture 34 of the top jaw surface 24, through the aperture 38 of the first and second arms 28, 30, and through an aperture 36 on the bottom jaw surface 26 at each of the opposing left and right jaw sides 20, 22.

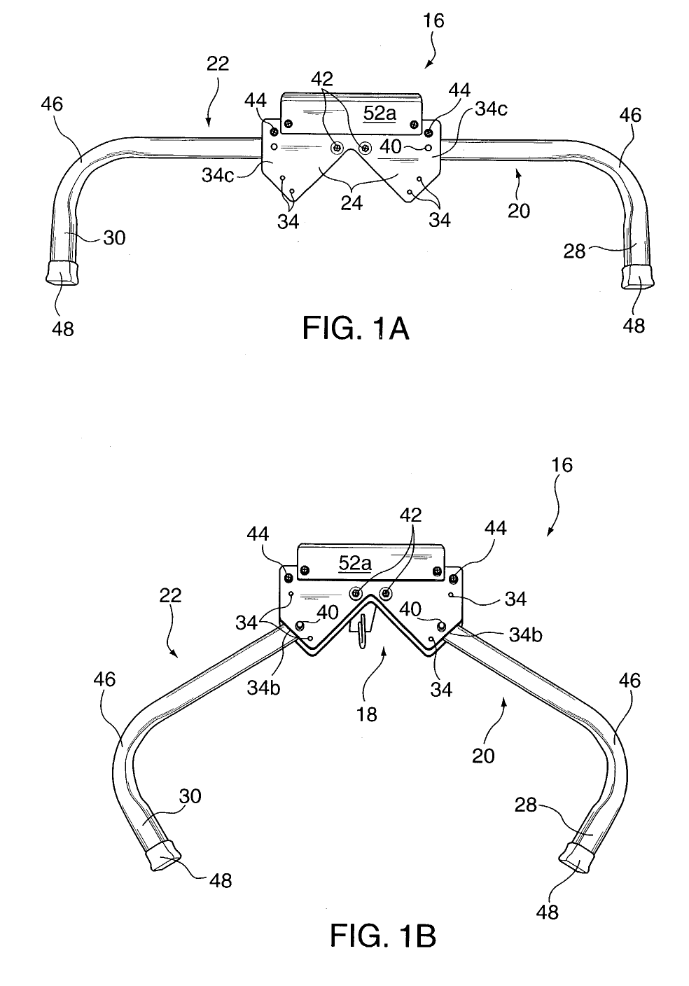

The top view of FIG. 1A shows the locking pin 40 through the lower most jaw surface apertures 34c, 36c on the two opposing sides 20, 22. FIG. 1C shows the locking pin 40 through the top-most jaw surface apertures 34a, 36a; and FIG. 1B shows the locking pin 40 through the mid-way jaw apertures 34b, 36b giving rise to the three different angulations of the arms 28, 30 forwardly of the jaw 18 as depicted in the drawings. As will be appreciated, the additional locking pins 42 anchor the arms 28, 30 within the jaw 18, and act as a fulcrum about which the arms 28, 30 may rotate from the angle of FIG. 1A to that of FIG. 1B to that of FIG. 1C. The further locking pins 44 will be understood to secure the top and bottom surfaces 24, 26 of the jaw 18 together.

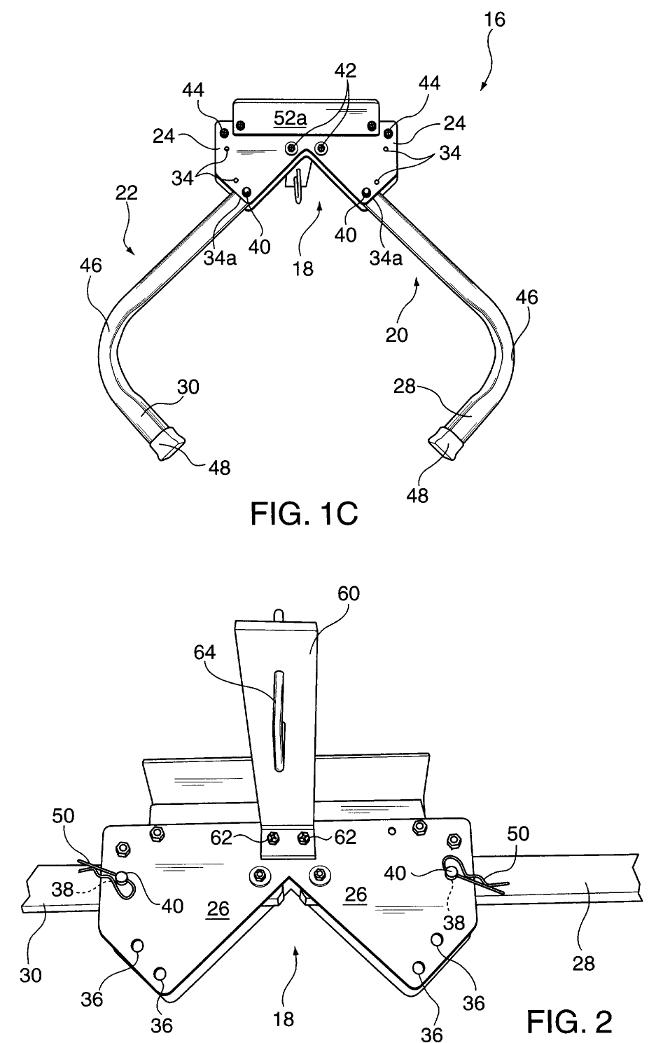

As will be appreciated by those skilled in the art, the left-to-right lengths of the arms 28, 30 could be selected equal or different, depending upon how the multipurpose ladder standoff is to be utilized; and the curved angles 46 of the arms 28, 30, could be equal or different, as well. Rubberized tips 48 are included at the ends of the arms 28, 30, to serve as a protective cushion upon whatever surface they may ultimately rest. The locking pins 40, when of cleavis type, could be secured once in place by a pair of cleavis pin retainers 50, as shown in FIG. 2.

Also shown in FIGS. 1A-1C—but more particularly in FIGS. 2 and 3—is a substantially L-shaped plate 52 secured to the top jaw surface 24 and extending downwardly therefrom. Such substantially L-shaped plate 52, secured to the top surface 24 by its own pair of locking pins 54, serves to rest the multipurpose ladder standoff atop one of the rungs of the ladder 10, such as at the rung 14a (FIG. 3). With its two sections 52a and 52b being slightly offset angularly one from another, and with a rubberized surface at their inside join, the plate 52 is then able to adjust to any typically sized and shaped rung 14a.

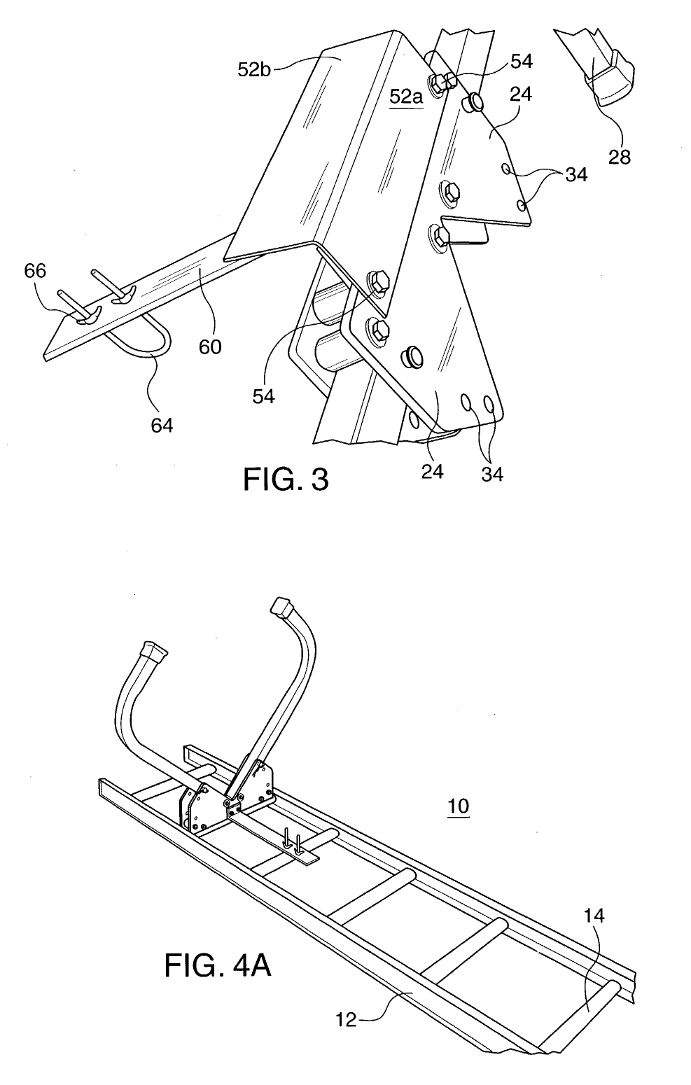

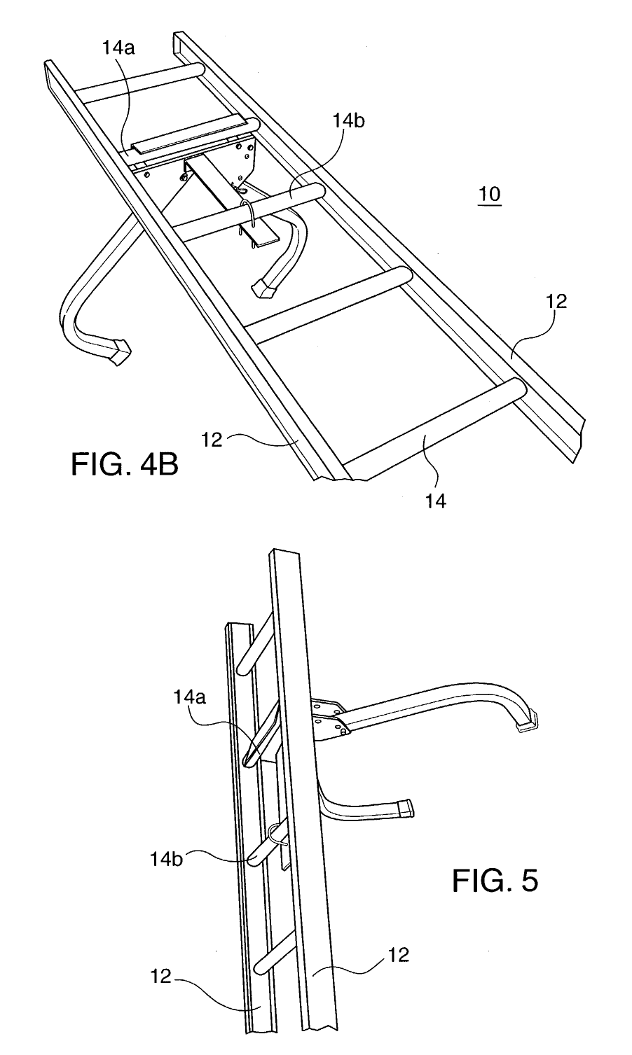

To secure the standoff 16 with the ladder 10, however, a substantially L-shaped extension 60 is further employed, similarly locked to the jaw 18, but at its bottom surface 26, by means of pins 62 to extend downwardly along at least one additional rung of the ladder, as to the rung 14b (FIGS. 4, 5). Such extension 60 includes its own pair of apertures in this preferred embodiment, to receive a threaded U-clamp 64 of a width to straddle such second ladder rung. The U-shape clamp 64 then receives its own screw nut fasteners 66 to secure the clamp 64 about the lower ladder rung for stabilization. As will be understood, tightening the fasteners 66 thus locks the ladder standoff 16 between the rungs 14a & 14b. Loosening the fasteners 66, on the other hand, permits the standoff 16 to simply be lifted away and removed.

Once the fasteners 66 are tightened, all that is required to utilize the standoff is to orient the two arms 28, 30 to the desired position within the jaw 18—simply by removing the clasp or cleavis pin retainer 50, rotating the arm(s) 28 or 30 between the aperture 34a, 36a or 34b, 36b or 34c, 36c desired, and then securing the arm(s) in position with the locking pin 40 and the clasp retainer 50 once again. Even for the do-it-yourselfer, this should take no more than 30-60 seconds to do—in allowing the arms 28, 30 to rotate about the jaw midpoint 70 between its two sides 20, 22 in preparing the ladder with its multipurpose standoff 16 ready for use.

By selecting the jaw 18, the arms 28, 30, the substantially L-shaped plate 52 and the substantially L-shaped extension 60 of aluminum or from such nonconducting materials as fiberglass or a carbon fiber composition, for example, a very sturdy standoff 16 results. By employing the same or different lengths for the arms 28, 30, by employing arms having the same or different curved angles 46, and by adjusting which of the “a” apertures, “b” apertures, or “c” apertures the pins 40 lock within, a wide configuration of uses could be obtained for the standoff. Thus, with the configuration of FIG. 1A, as an illustration, the standoff 16 could be used for leaning the ladder 10 against a planar exterior wall of the dwelling for ease in painting the wall—or for climbing the ladder to a point where one could safely and easily clear out leaf accumulation in the dwelling's gutter. Extending the ladder further could rest the arms with their rubberized tips against the roof to facilitate climbing on to it for replacing roof shingles or servicing a chimney. Alternatively, the angular rotations of FIG. 1B might be utilized with the arm 28 resting against a front or rear wall of the dwelling and with the second arm 30 turned to rest against a side wall to work around corners. With the arrangement of FIG. 1C, furthermore—as reproduced in FIG. 5—the standoff 16 could be used with the arms 28, 30 encircling a utility pole, flag pole, column or tree for that matter, in continuing to provide a very stable, solid emplacement which allows a worker to proceed with his/her task without the ladder slipping and throwing him/her off as a result.

While there have been described what are considered to be preferred embodiments of the present invention, it will be readily appreciated by those skilled in the art that modifications can be made without departing from the scope of the teachings herein of enabling individual rotatable orientations of one or both arms from the jaw of the ladder standoff, fixed between adjacent rungs or separate ones, in permitting a stable leaning to allow painting and/or servicing easily and safely. For at least such reason, therefore, resort should be had to the claims appended hereto for a true understanding of the scope of the invention.

I claim:

1. A multipurpose ladder standoff comprising:
a jaw having opposing left and right sides, and opposing top and bottom surfaces on each of said sides;
first and second arms individually rotatable forwardly from said left and right jaw sides between said top and bottom jaw surfaces, respectively;
first means cooperating with said arms and said jaw surfaces in locking said arms at selected angles of rotation forward of said jaw; and
second means coupled to at least one of said jaw surfaces to adjustably secure said jaw to at least one rung of a ladder substantially perpendicular to the legs thereof.

2. The multipurpose ladder standoff of claim 1 wherein said second means couples said top jaw surface to a first rung of said ladder and said bottom jaw surface to a lower, second rung of said ladder.

3. The multipurpose ladder standoff of claim 2 wherein said second means couples said top and bottom jaw surfaces between adjacent rungs of said ladder.

4. The multipurpose ladder standoff of claim 2 wherein said second means includes a substantially L-shaped plate secured to said top jaw surface and extending downwardly over said first rung of said ladder.

5. The multipurpose ladder standoff of claim 2 wherein said second means includes a substantially L-shaped extension secured to said lower jaw surface at one end and coupled with said lower, second rung of said ladder at a second remote end thereof.

6. The multipurpose ladder standoff of claim 5, also including a threaded U-clamp at said second remote end of said substantially L-shaped extension, and a pair of nut fasteners for securing said U-clamp about said lower, second ladder rung.

7. The multipurpose ladder standoff of claim 2 wherein said second means includes a substantially L-shaped plate secured to said top jaw surface and extending downwardly over said first rung of said ladder, wherein said second means also includes a substantially L-shaped extension secured to said lower jaw surface at one end and coupled with said lower, second rung of said ladder at a second remote end thereof, and also including a threaded U-clamp at said second remote end of said substantially L-shaped extension, and a pair of nut fasteners for securing said U-clamp about said lower, second ladder rung.

8. The multipurpose ladder standoff of claim 2 wherein each of said opposing top and bottom jaw surfaces include a plurality of overlying apertures on each of said opposing left and right jaw sides, wherein each of said first and second arms includes an aperture rotatable between opposing apertures of said top and bottom jaw surfaces, and wherein said first means includes first and second pins inserted through an aperture of said top jaw surface, said aperture of said first and second arms, and an aperture of said bottom jaw surface at each of said opposing left and right jaw sides.

9. The multipurpose ladder standoff of claim 8, also including a pair of removable clasps individually coupled through said first and second pins respectively, to lock said pins in position when inserted through said jaw surfaces and arm apertures and to allow removal of said pins for individual rotation of said first and second arms.

10. The multipurpose ladder standoff of claim 9, also including a further aperture at a first end on each of said first and second arms between further overlying apertures at first predetermined locations on each of said opposing top and bottom jaw surfaces on each of said opposing left and right jaw sides, and additionally including third and fourth pins extending through said further overlying apertures on each of said opposing left and right jaw sides to lock said arms at said jaw surfaces at said first predetermined locations.

11. The multipurpose ladder standoff of claim 10, including additional overlying apertures at second predetermined locations on each of said opposing top and bottom jaw surfaces on each of said opposing left and right jaw sides, and also including fifth and sixth pins extending through said additional overlying apertures on each of said opposing left and right jaw sides to lock said jaw surfaces at said second predetermined locations.

12. The multipurpose ladder standoff of claim 11 wherein each of said first and second arms are of a length between 2 and 4 feet.

13. The multipurpose ladder standoff of claim 12 wherein each of said first and second arms include rubberized cushion tips at a second end thereof opposite to said first end.

14. The multipurpose ladder standoff of claim 12 wherein said jaw, said first and second arms, said first means and said second means are composed of one of an aluminum and non-conducting material fabrication.

15. The multipurpose ladder standoff of claim 7 wherein each of said opposing top and bottom jaw surfaces include a plurality of overlying apertures on each of said opposing left and right jaw sides, wherein said of said first and second arms includes an aperture rotatable between opposing apertures of said top and bottom jaw surfaces, and wherein said first means includes first and second pins extending through an aperture of said top jaw surface, said aperture of said first and second arms, and an aperture of said bottom jaw surface at each of said opposing left and right jaw sides.

16. The multipurpose ladder standoff of claim 15, also including a pair of removable clasps individually coupled through said first and second pins respectively, to lock said pins in position when inserted through said jaw surfaces and arm apertures and to allow removal of said pins for individual rotation of said first and second arms, additionally including a further aperture at a first end on each of said first and second arms between further overlying apertures at first predetermined locations on each of said opposing top and bottom jaw surfaces on each of said opposing left and right jaw sides, and additionally including third and fourth pins extending through said further overlying apertures on each of said opposing left and right jaw sides to lock said arms at said jaw surfaces at said first predetermined locations, and wherein each of said first and second arms are of a length between 2 and 4 feet.

17. The multipurpose ladder standoff of claim 1 wherein each of said first and second arms are of a length between 2 and 4 feet.

18. The multipurpose ladder standoff of claim 17 wherein each of said jaw, said first and second arms, said first means and said second means are composed of one of an aluminum and non-conducting material fabrication.

19. The multipurpose ladder standoff of claim 1 wherein said second means couples said top jaw surface to a first rung of an extension ladder, and said bottom jaw surface to a lower, second rung of said extension ladder.

20. The multipurpose ladder standoff of claim 19 wherein said second means couples said top and bottom jaw surfaces between adjacent rungs of said extension ladder.
